(19) United States
(12) Patent Application Publication
(10) Pub. No.: US 2026/0110134 A1
(43) Pub. Date: Apr. 23, 2026

(54) HEAT PRESS WITH ADJUSTABLE PRESSURE AND METHOD OF USING THEREOF

(71) Applicant: Enetshops, LLC, Fullerton, CA (US)

(72) Inventors: Jimmy Lin, Yorba Linda, CA (US); Ta-Wei Chao, Shenzhen (CN)

(21) Appl. No.: 18/924,837

(22) Filed: Oct. 23, 2024

(51) Int. Cl. D06P 5/28; B41F 1/04; B41F 1/54; B41F 16/02; B41F 17/00

(52) U.S. Cl. CPC D06P 5/004; B41F 1/04; B41F 1/54; B41F 16/02; B41F 17/003

(57) ABSTRACT

Different transfer material and printing methods may require different heating temperatures, pressing durations, and applied pressure to have a design imprinted optimally on a substrate using a platen system of a heat press. The heat press disclosed herein may allow for the adjustment of applied pressure by the platen system in addition to the adjustment of the heating temperature and pressing duration. A user may be able to select from a plurality of preset pressure configurations the desired amount of pressure that the heat press should apply to the objects between the platen system. The applied pressure may be constant pressure or pressure increasing with time. A user may select from different magnitudes of constant pressure or rates of increasing pressure. Additionally, the heat press may have a pressure distribution system for evening out an upper platen to the lower platen when they are pressed together.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

The various aspects and embodiments described herein relate to a heat press with adjustable pressure and method of using thereof.

Heat presses may be used to design customized consumer goods, such as t-shirts, sweatshirts, photo panels, keychains, etc. For example, a t-shirt may be placed between the platen system of the heat press and a transfer material having a graphic design may be placed on top of the t-shirt and in between the platen system. The upper platen of the platen system may traverse down to press against the lower platen of the platen system to press and imprint the graphic design on the t-shirt by providing heat and pressure for a certain duration of time.

Accordingly, there is a need in the art for an improved device, system, and method for customizing consumer goods using a heat press.

### BRIEF SUMMARY

The various embodiments and aspects disclosed herein address the needs discussed above, discussed below and those that are known in the art.

A clam shell type heat press with adjustable pressure and method of using thereof is disclosed. A clam shell type heat press may be used to imprint a design on a substrate, such as a garment or photo panel. Different transfer material and printing methods may require different heating temperatures, pressing durations, and applied pressure to have the design imprinted optimally on the substrate using the platen system of the clam shell type heat press. The clam shell type heat press disclosed herein may allow for the adjustment of applied pressure by the platen system in addition to the adjustment of the heating temperature and pressing duration. A user may be able to select from a plurality of preset pressure configurations the desired amount of pressure that the platen system of the clam shell type heat press should apply to the objects therebetween. The applied pressure may be constant pressure or pressure increasing with time. The motor of the clam shell type heat press that automatically opens and closes the platen system may be able to provide a drive force at different magnitudes and/or provide a drive force that may increase with time. By way of example, the motor may be disposed below a lower platen of the platen system. The motor may be coupled to the upper platen of the platen system to provide such varying pressing forces. The motor may have a push rod that traverses the upper platen between an open position and a closed position. The motor is connected to the upper platen with a linkage. A user may select from different magnitudes of pressure using a user interface. The longer the motor is turned on, the greater the pressure applied between the upper and lower platens. The motor is said to be in an active state. Additionally, the clam shell type heat press may have a pressure distribution system for evening out an upper platen relative to the lower platen when they are pressed together. The pressure distribution system may have a plurality of compression springs coupled to the upper platen that allow such platen to adjust vertically to lay flat relative to the lower platen.

More particularly, a clam shell heat press for applying a preset pressure and heat between a graphic design and a garment to transfer the graphic design onto the garment is disclosed that may have a frame body, a lower platen attached to the frame body, the lower platen having an upper surface that is flat and horizontal, a pivot pin attached to the frame body, the pivot pin defining a rotational axis, an upper platen rotatably traversable about the pivot pin between an open position and a closed position, in the open position, the upper platen being spaced above the lower platen at an angle relative to the lower platen, and in the closed position, the upper platen having a flat lower surface configured to press the graphic design and the garment against the lower platen, an actuating arm coupled to the upper platen and configured to traverse the upper platen between the open position and the closed position, the actuating arm being pivotally attached to the pivot pin wherein the upper platen traverses between the open and closed positions by rotating the upper platen and the actuating arm about the pivot pin, a compression spring disposed between the actuating arm and the upper platen, a motor disposed underneath the lower platen, a first end portion of the motor being coupled to the frame body, a second end portion being coupled to the actuating arm, the motor configured to provide a driving force to rotate the upper platen between the open position and the closed position about the rotational axis, the motor configured to continue providing the driving force after the upper platen has contacted the lower platen to increase pressure to the preset pressure between the upper platen and the lower platen based on a length of time the motor remains in an active state, the motor configured to remain in a passive state to maintain the preset pressure for a time duration, and a digital controller having a user interface configured to adjust the pressure between the upper platen and the lower platen via the motor.

In some embodiments, the actuating arm has a first section and a second section, and the first and second sections are formed into an L shaped configuration.

In some embodiments, the second section of the actuating arm is shorter than the first section. In some embodiments, the second section is rotatably attached to the frame body with the pivot pin.

In some embodiments, the pivot pin is disposed behind the lower platen.

In some embodiments, the first end portion of the motor is rotatably coupled to the frame body underneath the lower platen.

In some embodiments, the second end portion of the motor is configured to extend away from the motor to move the upper platen to the closed position.

In some embodiments, the driving force provided by the motor increases with respect to time.

In some embodiments, the driving force provided by the motor is constant with respect to time.

Furthermore, a method for using a clam shell heat press to press a graphic design on a garment is disclosed that may include placing the garment between an upper platen and a lower platen of the clam shell heat press, placing a transfer material having the graphic design on top of the garment and between the upper platen and the lower platen, selecting on a user interface a heating temperature, selecting on the user interface a time duration that the upper platen will press against the lower platen, selecting on the user interface a preset configuration that determines a length of time that a motor attached to the upper platen will be in an active state and increases a pressure applied between the upper and lower platens in the active state, rotating the upper platen about a rotational axis of an actuating arm, the actuating arm connecting the motor to the upper platen, the motor disposed underneath the lower platen, until the upper platen applies a preset pressure to the lower platen based on the length of time that the motor is in the active state for applying the preset pressure between the graphic design and the garment, and maintaining a passive state of the motor for the time duration set in the step of selecting on the user interface the time duration.

In some embodiments, the motor is driven by a driving force that increases with respect to time.

In some embodiments, a rate of change of the driving force may be increased or decreased by selecting different preset configurations for pressure wherein each different preset configuration maintains the motor in the active state for each different periods of time of different preset configuration.

In some embodiments, the motor is driven by a driving force that is constant with respect to time in the passive state.

In some embodiments, a magnitude of the driving force in the passive state may be increased or decreased by selecting a different preset configuration for pressure.

In some embodiments, the motor is driven by a driving force that is constant as the upper platen rotates down on the lower platen and the driving force increases during the active state of the motor.

In some embodiments, the upper platen is coupled to a first section of the actuator arm and the motor is coupled to a second section of an actuator arm. In some embodiments, the actuator arm rotates about a pivot pin coupled to a frame of the clam shell heat press, the pivot pin defining the rotational axis of the actuator arm. In some embodiments, a compression spring is between the upper platen and the first section of the actuator arm that evenly distributes pressure on the graphic design and the garment being pressed by the upper platen. In some embodiments, wherein the motor is driven by a driving force that is constant as the upper platen rotates on the lower platen and the driving force increases as the motor experiences a resistive force from the compression spring.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1A shows a perspective view of a clam shell heat press in a closed position;

FIG. 1B shows a perspective view of a clam shell heat press in an open position;

FIG. 2A shows another view of the clam shell heat press where the structural components of the device may be seen clearly;

FIG. 2B shows a bottom view of the clam shell heat press with part of the frame body removed to show the motor of the heat press;

FIG. 2C shows a rear view of the clam shell heat press with the majority of the frame body removed to clearly see the components of the motor of the heat press;

FIG. 2D shows a side view of the different components of the actuation system of the clam shell heat press;

FIG. 2E shows the heating element of the clam shell heat press;

FIG. 3A shows a close-up view of the user interface of the clam shell heat press;

FIG. 3B shows a side-view of the clam shell heat press having a garment and transfer material between the platen system; and

FIGS. 3C-E show the upper platen pressed down on the lower platen at different pressure settings.

### DETAILED DESCRIPTION

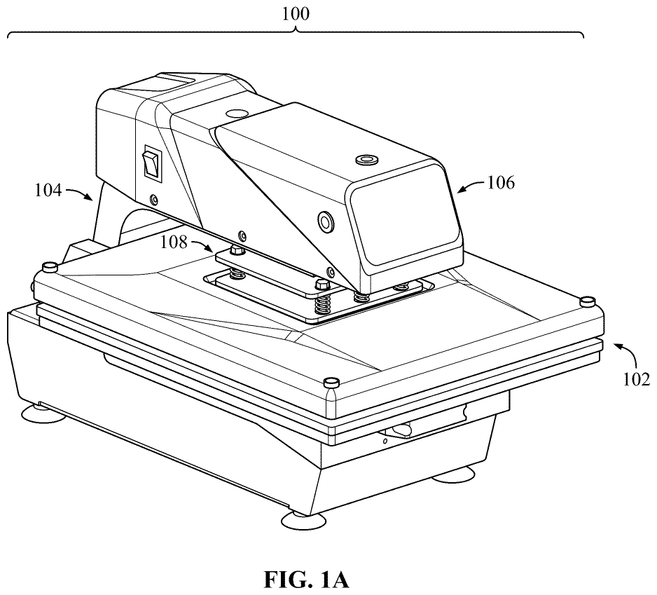

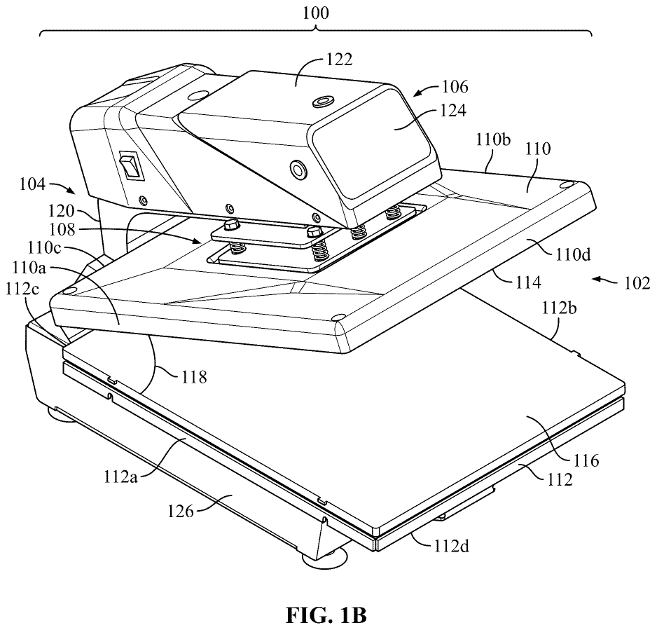

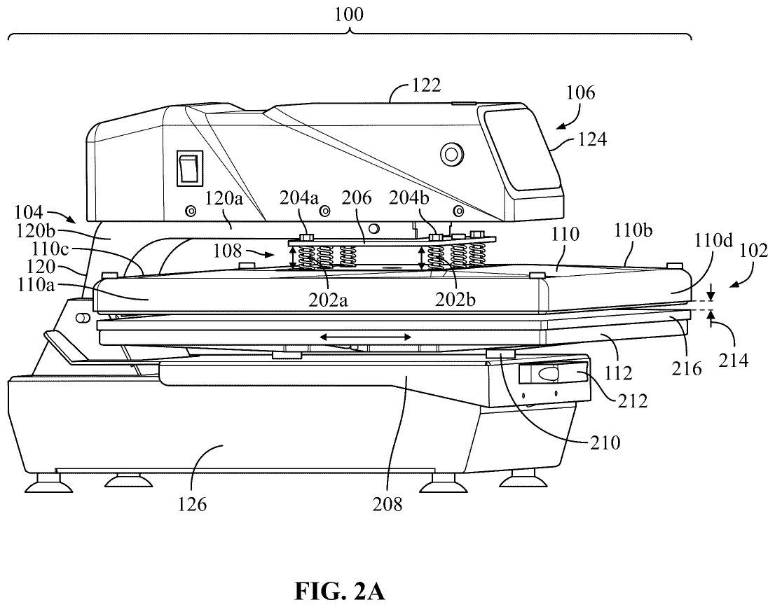

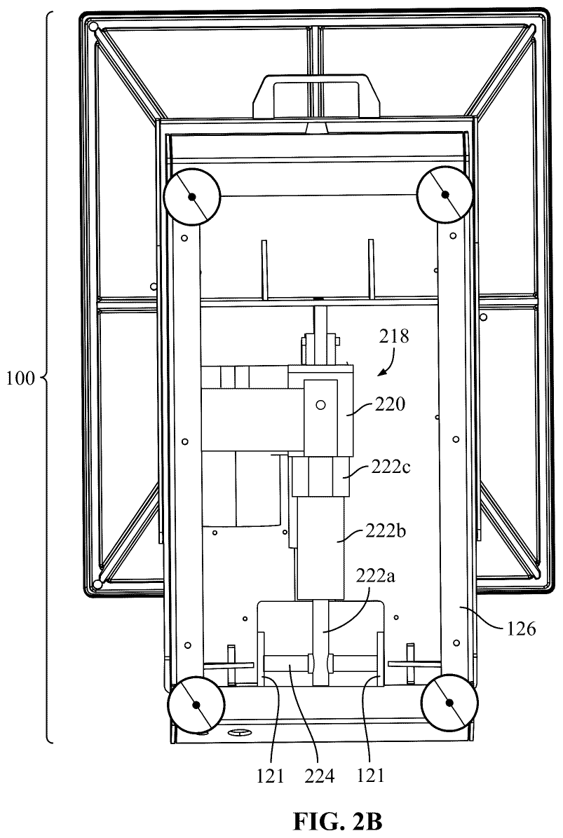

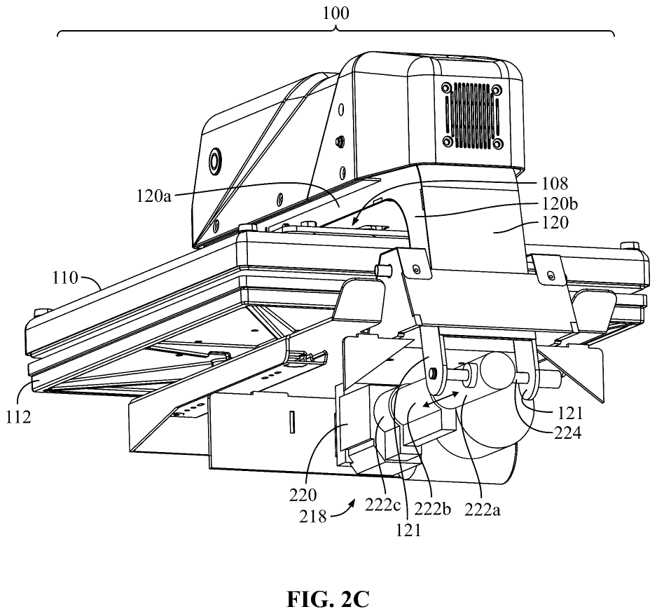

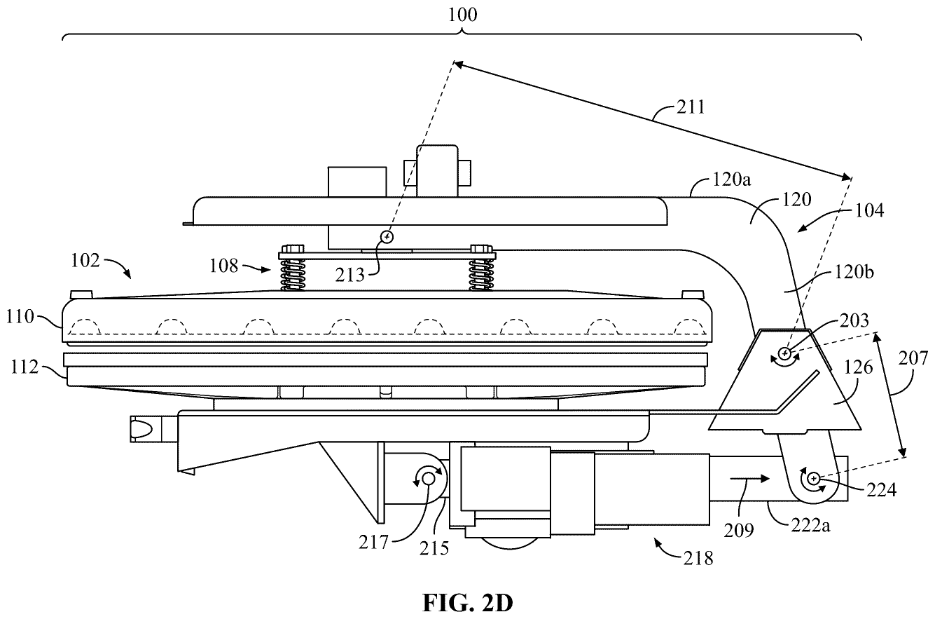

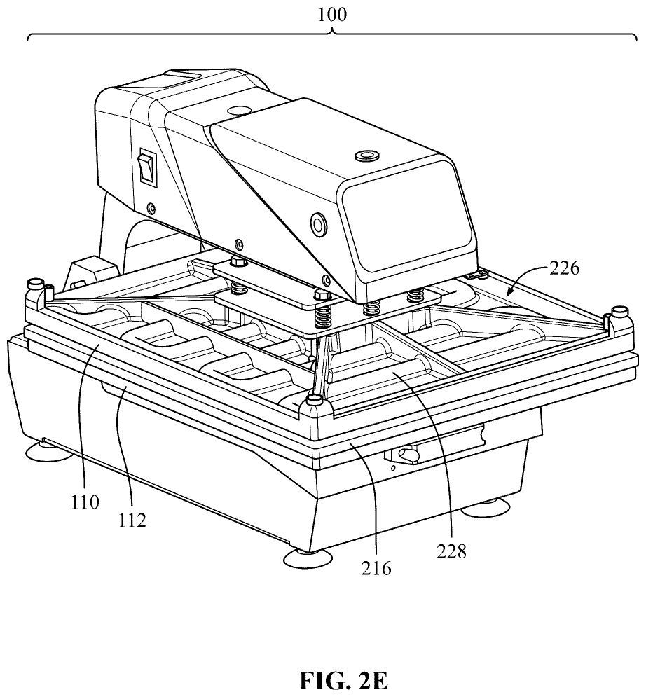

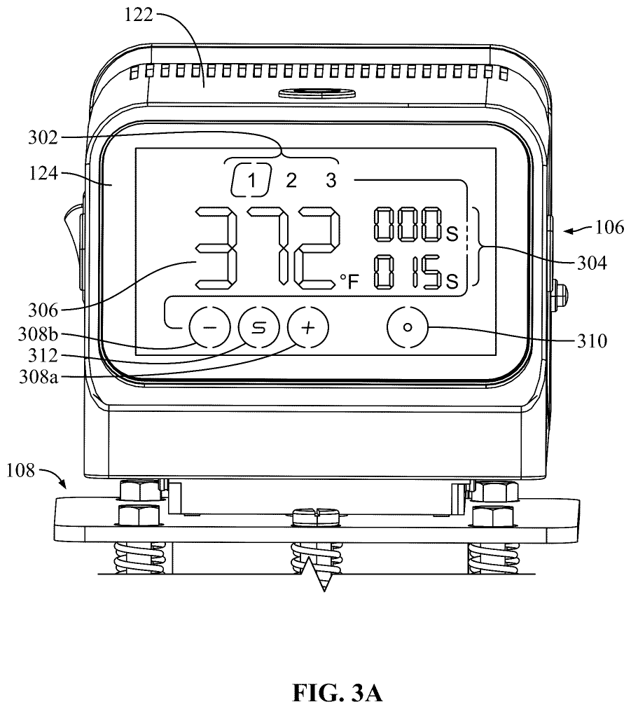

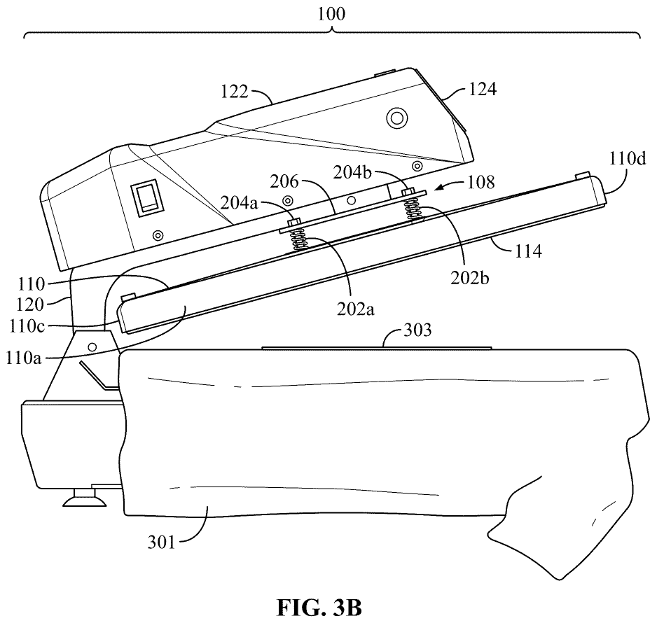

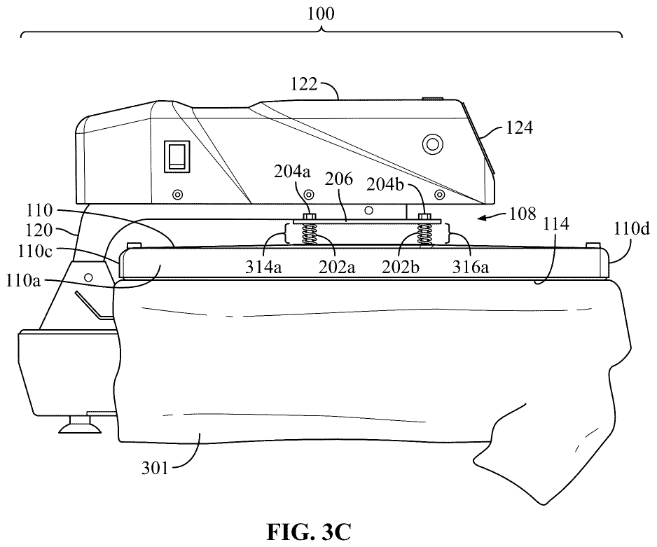

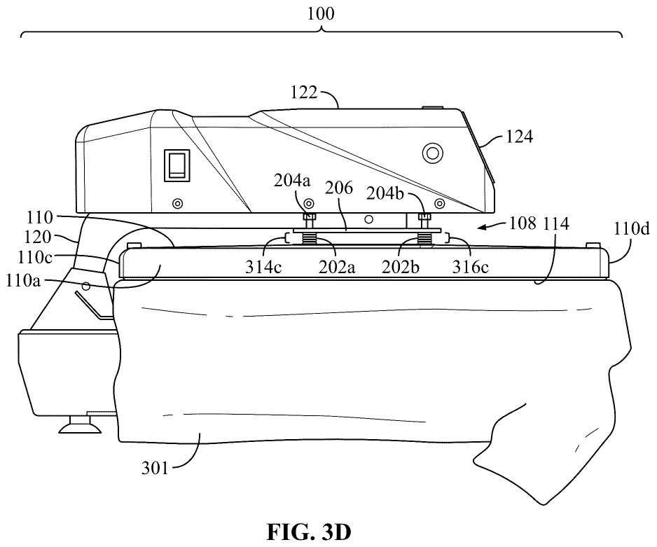

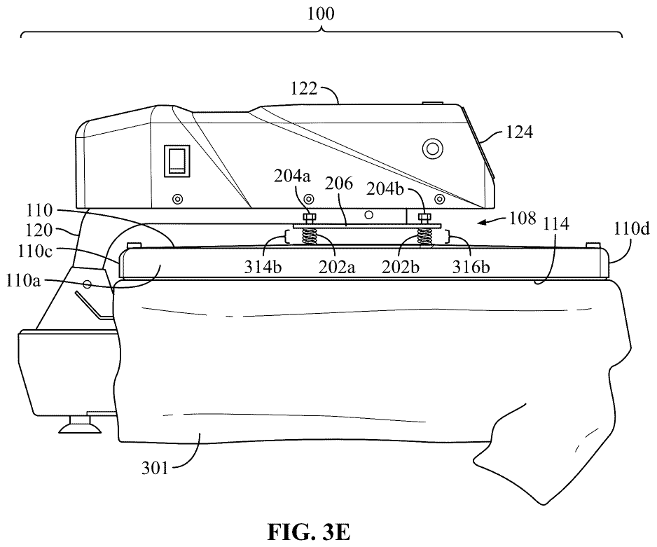

Referring now to the Figures, a clam shell heat press 100 is shown that automatically closes and opens the platen system 102. The platen system 102 may be configured to provide the necessary heat and pressure for a specific duration of time to imprint a graphic design, which may originally be on a transfer material 303 (see FIG. 3B), on a garment 301 or substrate. The heating temperature, pressing time, and even the pressure applied by the platen system 102 may be adjusted to fit the needs of the material used and type of printing done by the device. Such adjustments may be executed using a digital controller 106 of the clam shell heat press 100. The applied pressure may be constant or increase as function of the duration of time that the motor 218 (see FIG. 2B) of the clam shell heat press 100 is turned on. The longer the motor 218 is in an active state, the greater the applied pressure. The shorter the motor 218 is in the active state, the lower the applied pressure. In one example, the touch pad screen 124 (see FIG. 3A) may display a plurality of preset configurations 302 where each configuration corresponds to a different magnitude of constant pressure, from light to heavy, that the upper platen 110 (see FIG. 1B) may apply to the lower platen 112. In another example, the preset configurations 302 may correspond to an amount of time that the motor 218 of the device is in operation, from short duration (e.g., 1 to 6 seconds) to long duration (e.g., 15 to 20 seconds), and the force and the pressure that the motor 218 applies is not constant but rather increases with the duration of time that the motor is turned on (i.e., the motor is in operation). The clam shell heat press 100 may also have a pressure distribution system 108 (see FIG. 1A) that evenly flattens the upper platen 110 (see FIG. 1B) with the lower platen 112 and distributes the applied pressure along the platen system 102. The pressure distribution system 108 may be important if a thick garment or substrate is being placed between the platen system 102. This may be because the upper platen 110 is above the lower platen 112 in an angle at the open position (see FIG. 1B), and consequently the rear lateral sides 110c, 112c contact the garment before the front lateral sides 110d, 112d.

Referring specifically now to FIG. 1A, a perspective view of the clam shell heat press 100 is shown. Among other things, the clam shell heat press 100 may have a platen system 102, an actuation system 104, a pressure distribution system 108, and a digital controller 106. Such structures may operate together to provide the necessary heating temperature, pressing time, and applied pressure to imprint a graphic design on a garment 301 (see FIG. 3B) or substrate.

As shown in FIG. 1B, the platen system 102 may have a lower platen 112 and an upper platen 110. In the closed position, as shown in FIG. 1A, the upper and lower platens 110, 112 may lay generally flat on top of each other and both be generally in the horizontal orientation. In the open position, as shown in FIG. 1B, the lower platen 112 may be orientated horizontally and the upper platen 112 may be spaced apart and inclined above the lower platen 112. The incline orientation of the upper platen 112 in the open position may make the heat press 100 as a clam shell type heat press. The upper platen 112 may have a heating element 226 therein, as shown in FIG. 2E, where the heating element 226 may heat up and provide the necessary heating energy to imprint the graphic design of the transfer material 303 (see FIG. 3B) onto the garment 301 or a substrate when the upper platen 112 is pressed against the lower platen 110. The garment 301 that may be heat pressed, for example, be a t-shirt or sweatshirt. The substrate that may be heat pressed may, for example, be a photo panel or keychain.

The actuation system 104 may move the upper platen 110 between the close and open positions. The actuation system 104 may close and open the platen system 102 automatically and without a user having to manually lift down and up the upper platen 110. Among other things, the actuation system 104 may have an actuator arm 120 (see FIG. 1B) coupled to a motor 218 (see FIG. 2B-C) of the heat press 100. As described elsewhere herein, the motor 218 may provide a constant force/torque or an increasing force/torque, with respect to time, to the actuator arm 120 to press the upper platen 110 on the lower platen 112 at a constant or increasing pressure. The magnitude of the constant pressure may be adjusted and selected by the user via the digital controller 106. By way of example and not limitation, the user can control the amount of time that the motor 218 is in the active state. A longer period of time that the motor 218 is in the active state causes the upper platen 110 to apply a greater force or pressure on the lower platen 112 compared to a shorter period of time that the motor 218 is in the active state. The duration of time the motor 218 is turned on when providing the increasing pressure may be adjusted and selected by the user via the digital controller 106.

The pressure distribution system 108 may evenly distribute pressure between the inner surface areas 114, 116 (see FIG. 1B) of the upper and lower platens 110, 112 and the garment or substrate that may be therebetween. As shown in FIG. 1B, the upper platen 110 may be open at an angle relative to the lower platen 112. The pressure distribution system 108 may make sure that the front lateral sides 110d, 112d of the upper and lower platens 110, 112 lay evenly flat with the rear lateral sides 110c, 112c in the closed position, even if a thick garment or substrate is placed between the two platens. In the open position, the upper platen 110 may be inclined upwards from the rear lateral side 110c to the front lateral side 110d. Consequently, the pressure distribution system 108 may be needed to allow for the even contacting of the inner surface 114 of the upper platen 110 on the garment or substrate, when actuating such structure in the closed position. The pressure distribution system 108 may also provide a restoring force to control pressure provided by the actuation system 104, which such restoring force may be depended on the spring constant and vertical displacement of the springs that make up the pressure distribution system 108.

The digital controller 106 shown in FIG. 1A may control the operation of the clam shell heat press 100. As shown in FIG. 3A, the digital controller 106 may have a user interface in the form of a touchpad screen 124 that may allow the user to select and adjust the heating temperature 306, duration of time 304, and applied pressure. The applied pressure may be selected from a plurality of preset configurations 302, which such configurations may be programmed to adjust and provide different magnitudes of constant pressure or increasing pressure over the time the motor 218 (see FIG. 2B) is turned on. The digital controller 106 may also have a controller housing 122 storing at least some of the electrical components of the digital controller 106.

FIGS. 2A-D show the main components of the actuating system 104 and how the heat press motor 218 is coupled to the actuator arm 120. In different examples, the heat press motor 218 may be designed to provide compressing force in different ways. As shown in FIG. 2B, the heat press motor 218 may be inside the body frame 126 of the clam shell heat press 100.

As shown in FIG. 2C, the leading shaft 222a of the motor 218 may be coupled to the short leg 120b of the actuator arm 120. As described elsewhere herein, the actuator arm 120 may be L-shaped having a long leg 120a extending along the length of the upper platen 110 and a short leg 120b at the rear side of the upper platen and extending downwards in the frame body 126 and towards the motor 218. The end of the short leg 120b of the actuator arm 120 may diverge and have two coupling plates 121 spaced from each other. The coupling plates 121 may be seen as two prongs having the leading shaft 222a of the motor 218 therebetween. The coupling plates 121 may each have a pin hole to fasten to the leading shaft 222a of the motor 218. A fastening pin 224 (see FIGS. 2C and 2D) may fasten the coupling plates 121 of the actuator arm 120 with the leading shaft 222a of the motor 218. The fastening pin 224 may extend through the pin holes of the two coupling plates 121 and through the diameter thickness of the leading shaft 222a. The ends of the fastening pin 224 proximate to the outer surfaces of the coupling plates 121 may be fastened to interlock the leading shaft 222a with the short leg 120b of the actuator arm 120.

As shown in FIG. 2C, the motor 218 may be a linear actuator motor having one or more telescoping shafts 222a-c. The motor 218 may be disposed below the lower platen 112 within the frame 126 of the heat press 100. In this way, the foot print of the heat press is minimized and closely approximates the upper and lower platens 110, 112. The motor 218 may expand and retract the leading shaft 222a away and towards the motor body 220. When the motor 218 expands the leading shaft 222a away from the motor body 220, and towards the rear end of the heat press 100, the leading shaft 222a may push the actuator arm 120 to close and press the upper platen 110 on the lower platen 112. When the motor 218 is turned on, the motor 218 expands the leading shaft 222a away from the motor body 220, which in turn applies pressure onto the lower platen 112 by the upper platen 110. The longer period of time that the motor 218 is turned on and in the active state, the greater pressure that the upper platen 110 applies to the lower platen 112. When the motor 218 is no longer in the active state, the pressure being applied by the upper platen 110 to the lower platen 112 is set to the then applied pressure. The time period that the motor 218 is in the active state determines the applied pressure of the upper platen 110 on the lower platen 112. When the motor 218 retracts the leading shaft 222a towards the motor body 220, and away from the rear end of the heat press 100, the leading shaft 222a may pull the actuator arm 120 to open the upper platen 110 away from the lower platen 112. It is contemplated that the motor 218 is retracted to the same angular position in the open position so that the upper platen 110 is at the same angular start position when the motor 218 is turned on again to traverse the upper platen 110 to the closed position for the set period of time. In this manner, the time that the motor 218 is turned on and traversing the upper platen 110 toward the closed position, then no longer in the active state, determines the constant applied force of the upper platen 110 on the lower platen 112 when the unit is in the closed position. When the shirt (i.e., base material 301) and the transfer material 303 are disposed between the upper platen 110 and lower platen 112, the time that the motor 218 is turned on in the active state and traversing the upper platen 110 from the starting open position consistently applies a consistent pressure to the transfer material 303, the base material 301, and to the lower platen 112. As shown in FIG. 2D, the end 215 of the motor 218 that is on the opposite side of the leading shaft 222a may be pivotably fastened to the inside of the frame 126 at a second pivot joint 217. The pivot joint 217 may allow the motor 218 to rotate clockwise and counterclockwise about the pivot joint 217 when the leading shaft 222a pulls and pushes the actuator arm 120 so that the platen system 102 is traversed between the open and closed positions. In this way, the leading shaft 222a can move up and down as needed as the fastening pin 224 rotates about rotational axis 205. The inner cavity of the frame 126 holding the motor 218 may have enough spacing to allow the leading shaft 222a to change its positioning as described.

In some examples, the motor 218 may have a plurality of telescoping shafts 222a-c (see FIG. 2C) that expand and retract with each other when the rotor system in the motor body 220 is operated. The motor being on, as mentioned herein, may be defined as the motor providing driving force to the leading shaft 222a. In some examples, the driving force may be one or more forces (e.g., constant or varying forces) that pushes the leading shaft 222a away from the motor body 220 to move and press the upper platen 110 on the lower platen 112, as described herein. In other examples, the driving force may be a combination of forces that includes pushing the leading shaft 222a away from the motor body 220 to move and press the upper platen 110 on the lower platen 112 and also pulling the leading shaft 222a towards the motor body 220 to open the upper platen 110 from the lower platen 112, as described herein. In other examples, the motor being on, as mentioned elsewhere herein, may be defined as the motor providing driving force to the plurality of telescoping shafts 222a-c. In some examples, the driving force may be one or more forces (e.g., constant or varying forces) that pushes the plurality of telescoping shafts 222a-c away from the motor body 220 to move and press the upper platen 110 on the lower platen 112, as described elsewhere herein. In other examples, the driving force may be a combination of forces that includes pushing the plurality of telescoping shafts 222a-c away from the motor body 220 to move and press the upper platen 110 on the lower platen 112 and also pulling the plurality of telescoping shafts 222a-c towards the motor body 220 to open the upper platen 110 from the lower platen 112, as described elsewhere herein. If the motor provides an increasing driving force over time, then the motor may be characterized as being in an active state. If the motor is still on but provides a constant drive force level over time, then the motor may be in a passive state.

As shown in FIG. 2C, a pivot pin 203 may be coupled to the short leg 120b of the actuator arm 120. In some examples, the pivot pin 203 may be coupled to the long leg 120a of the actuator arm 120 or in between the long leg 120a and the short leg 120b. The actuator arm 120 may rotate about the pivot pin 203 and traverse the upper platen 110 between the closed and open positions as shown in FIGS. 1A-B. The pivot pin 203 may be configured to convert the translational driving force produced by the linear motor 218 into torque so as to rotate the actuator arm 120 between the closed and open positions. The pivot pin 203 may also translate the driving force produced by the linear motor 218 into torque on the actuator arm 120 and cause the upper platen 110 to exert pressure or downward force on the lower platen 112. The pivot pin 203 may be coupled to the short leg 120b and extend laterally through the width of the short leg 120b. Moreover, the pivot pin 203 may be attached to the frame 126 of the heat press 100 where the lower platen 112 may be fixedly attached to such frame 126. Consequently, the actuator arm 120 may rotate and pivot relative to the frame 126 of the heat press 100 having the lower platen 112 since the pivot pin 203 is coupled to the frame 126 as well. The pivot pin 203 may define a rotational axis 205 that extends laterally along the width of the short leg 120b. The rotational axis 205 defines the rotation of the actuator arm 120 between the closed and open positions. As the leading shaft 222a of the motor 218 retracts towards the motor body 220, and in reference to FIG. 2D, the short leg 120b may rotate clockwise about the rotational axis 205 (see FIG. 2C) created by the pivot pin 203. This may also rotate the long leg 120a, fixedly linked to or formed with the short leg 120b, in the clockwise direction and move the upper platen 110 to the open position. As the leading shaft 222a of the motor 218 expands away from the motor body 220, and in reference to FIG. 2D, the short leg 120b may rotate counterclockwise about the rotational axis 205 (see FIG. 2C). This may also rotate the long leg 120a, linked to or formed with the short leg 120b, in the counterclockwise direction and move the upper platen 110 to the closed position. In the closed position, the motor 218 may continue to stay in a passive state and provide the forward driving force. In the passive state, the motor provides a consistent pressure between the upper and lower platens equal to the pressure when the motor switched from the active state to the passive state. The forward driving force may be translated to torque about the pivot pin 203 that presses the upper platen 110 onto the lower platen 112 and provide constant or increasing pressure, described herein.

The actuation system 104 may apply pressure to the platen system 102 when the upper platen 110 closes on the lower platen 112. The applied pressure may be constant or increase with time, and the magnitude or rate of the applied pressure may be adjustable and conveniently selected using the digital controller 106. Pressure may be a function of force divided by the area that the force is being applied thereto, where the motor 218 may provide the force creating the pressure. Consequently, the motor 218 may be configured to provide constant forces at different magnitudes or at different rates of increasing force with respect to time. To provide pressure to the platen system 102, the duration of time the motor 218 is turned on may be greater than the duration of time that the upper platen 110 traverses to close upon the lower platen 112. In some examples, the more the motor 218 is on and driving the leading shaft 222a, the more the force and pressure applied to the platen system 102 increases with time.

In some examples, the magnitude of the constant applied pressure that the upper platen 110 presses on the lower platen 112 may be selected from a plurality of preset configurations 302 (see FIG. 3A). The touch pad screen 124 may display two or more options that the user may select that determines with what amount of constant force the motor 218 will actuate the actuator arm 120 and press the upper platen 110 on the lower platen 112. The plurality of preset configurations 302 may allow the user to select a light pressure, a medium pressure, and a high pressure, where the light pressure is less than the high pressure and the medium pressure is therebetween. In practice, the unit may bring the upper platen 110 to the same starting open position. From this starting position, a time may be selected in which the motor 218 is turned on in the active state to traverse the upper platen 110 toward the lower platen 112 and increase pressure. During the period of time, the motor 218 traverses the upper platen 110 toward the lower platen 112. When the upper platen 110 presses on the transfer material 303, the upper platen 110 may stop moving yet the pressure applied to the transfer material 303, base material 301, and the lower platen 112 may continue to increase. The motor 218 is still in the active state for a user-set period of time. After the set period of time that the motor 218 is in the active state has been reached, the pressure applied to the transfer material 303, the base material 301 (e.g., shirt), and the lower platen 112 may be consistently held. The motor 218 is now in the passive state. The passive state may last until the lower platen 112 begins to be traversed back toward the open position. The motor 218 may traverse the upper platen 110 back to the same starting position. The user may also select for how long such selected constant pressure is applied by adjusting the timer 304 (see FIG. 3A) that may correspond to how long the upper platen 110 is closed on the lower platen 112. During such duration of time selected by the user on the timer 304, the motor 218 may be turned on and provide the necessary force to maintain the constant pressure level selected from the preset configurations 302. Alternatively, the motor 218 may turn off after the upper platen 110 is pressed against the lower platen 112 at the selected constant pressure amount. The leading shaft 222a may be locked into place to prevent the upper platen 110 from displacing away from the lower platen 112, under the achieved constant pressure, until the time duration selected by the user has lapsed.

In other examples, the generated motor force creating the pressure for the platen system 102 may increase as time lapses and the motor 218 while the motor is in an active state. The motor 218 may be designed to increase the driving force of the leading shaft 222 a pressing the upper platen 110 on the lower platen 112 from the moment the motor 218 is turned on to actuate the platen system 102. The driving force of the motor 218 may linearly or non-linearly increase with time. For example, the driving force of the motor 218 may increase at a lower rate in the beginning, when the upper platen 110 does not contact the lower platen 112, and increase at a higher rate afterwards, when the upper platen 110 contacts the lower platen 112. The driving force increasing from the moment that the motor 218 is turned on may ease designing and implementing the increase in pressure done by the heat press 100.

The user may select from the preset configurations 302 (see FIG. 3A) the amount of time the motor 218 is turned on and providing the increasing pressure. A lowest pressure preset option may correspond to the shortest amount of time the motor 218 is turned on since the driving force of the motor increases with time. A highest pressure preset option may correspond to the longest amount of time the motor 218 is turned on since the driving force of the motor increases with time. The medium pressure preset option may be a time duration in between the low and high pressure preset options. By way of example and not limitation, the low pressure preset option may correspond to the motor being turned on for five to 10 seconds. By way of example and not limitation, the medium pressure preset option may correspond to the motor being turned on for 11 to 15 seconds. By way of example and not limitation, the high pressure preset option may correspond to the motor being turned on for 15 to 20 seconds. Such duration range is by way of example and the low, medium, and high time range described may overlap.

In some examples, the motor 218 may turn off after the upper platen 110 is pressed against the lower platen 112 when the selected the level of pressure is reached (that may increase with time, as described elsewhere herein). The leading shaft 222a may be locked into place to prevent the upper platen 110 from displacing away from the lower platen 112, under the achieved pressure, until the time duration selected by the user on the timer 304 (see FIG. 3A) has lapsed, which the timer 304 may have a different time (e.g., longer) than the time the motor 218 is turned on to increase pressure.

In other examples, the generated motor force may be constant when moving the upper platen 110 towards the lower platen 112, and the generated motor force may increase with time when the upper platen 110 is closed and pressing on the lower platen 112. Consequently, unwanted acceleration and increase in speed, when the upper platen 110 is moving towards the lower platen 112, may be mitigated. The platen system 102 may have a sensor that relays to the digital controller 106 when the upper platen 110 is closed on top of the lower platen 112. When the upper platen 110 is in the closed position, the digital controller 106 may then relay to the motor 218 to increase the driving force creating the pressure on the lower platen 112 with respect to time. By way of example and not limitation, the sensor of the platen system 102 may be a magnetic sensor that detects when the upper platen 110 is locked on the lower platen 112 by the magnetic lock between the two structures, as described elsewhere herein.

In another example, the digital controller 106 may be programmed to know the amount of time that is needed to close the upper platen 110 on the lower platen 112. The digital controller 106 may relay to the motor 218 to provide a constant driving force during such duration of time and increase the driving force over time when such amount of time has lapsed, which such lapse of time may be indicative of the upper platen 110 being closed on top of the lower platen 112. In the aforementioned examples, the duration of time the motor runs when the upper platen 110 is closed and pressed on top of the lower platen 112, and hence the applied pressure increasing over time, may be selected from preset configuration options on the touchpad 124, as described elsewhere herein. A low pressure preset option may correspond to the shortest amount of time the motor 218 is turned on since the driving force of the motor increases with time. A high pressure preset option may correspond to the longest amount of time the motor 218 is turned on since the driving force of the motor increases with time. The medium pressure preset option may be a time duration in between the low and high pressure preset options. The duration of increasing force may equal to the duration that the upper platen 110 and lower platen 112 are pressed together. Alternatively, the motor 218 may be turned off and the leading shaft 222a of the motor may lock into place after the duration of increasing force has lapsed but further time is needed for heat pressing, as described elsewhere herein.

In other examples, the generated motor force may begin increasing over time as the motor 218 experiences a resistive force caused by the upper platen 110 pressing against the lower platen 112. As the upper platen 110 presses against the lower platen 112, the leading shaft 222a of the motor 218 may decelerate and stop moving. The motor 218 may then increase the force driving the leading shaft 222a over time up to a threshold force, which may be reached after the lapse of certain amount of time. Consequently, the pressure that the upper platen 110 applies to the lower platen 112 may increase over time as the motor 218 experiences a resistive force. The threshold force reached by the motor 218 over a certain amount of time may be selectable by the preset configurations 302 (see FIG. 3A), which may correspond to low, medium, and high pressure, as described elsewhere herein. The selection may be based on how long the motor 218 is turned on, as described elsewhere herein. The motor 218 may be designed to not go above the threshold force to prevent damaging the motor 218. In some examples, the spring restoring force of the compression springs 202a-b (see FIG. 2A) may be the resistive force that triggers the motor 218 to increase the motor drive force over time. The motor 218 may be designed to maintain a constant pressure after overcoming the spring restoring force, which such spring force may be the maximum restoring force (e.g., when the springs 202a-b are fully compressed) or a fraction of the maximum restoring force. Alternatively, the motor 218 may be turned off and the leading shaft 222a of the motor may lock into place when the threshold force is reached by the motor 218 after experiencing the resistive force, as described elsewhere herein, to maintain pressure.

In another example, one or more pressure sensors may be placed under the inner surface 116 of the lower platen 112 that detects the pressure that is being applied by the upper platen 110. The motor 218 may increase the drive force applying pressure to the lower platen 112 until a threshold pressure is sensed by the pressure sensor and relayed to the digital controller 106. When such threshold pressure sensor is reached, the motor 218 may then continue providing a constant driving force that maintains the threshold pressure on the inner surface 116 of the lower platen. Alternatively, the motor 218 may shut off when the threshold pressure is sensed by the one or more pressure sensors, as described elsewhere herein.

The one or more pressure sensors may be located around the center of the inner surface 116 of the lower platen 112 to get an accurate reading of the pressure being applied by the upper platen 110. Alternatively, the one or more pressure sensors may be evenly distributed across the inner surface 116 of the lower platen 112. The one or more pressure sensors being on the lower platen 112 may help the sensors avoid overheating from the heat produced by the upper platen. The magnitude of the threshold pressure sensed by the one or more pressure sensors may be adjusted using the plurality of preset configurations 302, as described elsewhere herein. The threshold pressure may be adjusted to a low pressure magnitude, a high pressure magnitude, or a medium pressure magnitude between the low and high pressure, as described elsewhere herein.

In another example, the driving force generated by the motor 218 may change based on the change in electric characteristics of the motor 218. The motor 218 may communicate with the digital controller 106. The motor 218 may continue increasing the driving force that applies pressure on the lower platen 112 until, for example, the resistive force produced by the lower platen 112 hinders the leading shaft 222a to a point where the electric current in the motor 218 reduces to a predetermined amount. When such predetermined reduced amount of electric current is present in the motor 218, the digital controller 106 may shut off the motor, as described elsewhere herein.

Torque is defined as the cross-product of length and force vectors. With reference to the actuation system 104 of the clam shell heat press 100, as shown in FIG. 2D, the torque generated on the short leg 120b of the actuator arm 120 may determine the amount of pressure the long leg 120a provides on the platen system 102. Regarding the short leg 120b of the actuator arm 120, the length in the torque formula may be the distance 207 between the fastening pin 224 (coupling the leading shaft 222a of the motor 218 to the short leg 120b) and the pivot pin 203. The force in the torque formula may be the driving force 209 that the leading shaft 222a pushes on the short leg 120b at the fastening point defined by the fastening pin 224.

If the direction of the length and force vectors relative to each other do not change in the cross-product formula of torque, the same amount of torque may be generated on the short leg 120b using less motor driving force 209 by proportionally increasing the value of the distance 207 between the fastening pin 224 and the pivot pin 203. Such reduction in the magnitude of necessary force may reduce wear and tear on the motor 218 and its internal parts when the leading shaft 222a is stagnated at exerting force to achieve the selected desired pressure on the platen system 102. By way of example and not limitation, the distance 207 between the fastening pin 224 and the pivot pin 203 may be between three to eight inches to reduce the driving force needed for the motor 218 to generate and achieve the selected desired pressure on the platen system 102. In other examples, the distance 207 between the fastening pin 224 and the pivot pin 203 may be greater than eight inches. Alternatively, the distance 207 between the fastening pin 224 and the pivot pin 203 may be increased, and the same driving force 209 may be used to create more torque generating greater pressure on the platen system 102.

The distance 211 between the pivot point 203 on the short leg 120b and the pressing point 213 on the long leg 120a, which applies the generated force/torque on the pressure distribution system 108 and the platen system 102, may need to be greater than the distance 207 between the fastening pin 224 and the pivot pin 203. This may be for the same reasons as described with respect to the distance 207 range between the fastening pin 224 and the pivot pin 203. Such reasons may be to reduce the necessary driving force 209 generated by the motor 218 or, alternatively, generate more torque using the same amount of force. By way of example and not limitation, the distance 211 between the pivot point 203 on the short leg 120b and the pressing point 213 on the long leg 120a may be two to five times the distance 207 between the fastening pin 224 and the pivot pin 203. As such, the motor 218 may experience less wear and tear on its internal parts when the leading shaft 222a is stagnated at exerting force to achieve the selected pressure on the platen system 102.

Referring now to FIG. 2A, the pressure distribution system 108 will be described further. The pressure distribution system 108 may horizontally flatten the inner surface 114 (see FIG. 1B) of the upper platen 110, which is heated by the heating element 226 (see FIG. 2E), on the garment or substrate that is being pressed. As such, the heat and pressure may be distributed evenly on the transfer material 303 and the garment 301 (see FIG. 3B). Since in the open position the front lateral side 110d may be inclined above the rear lateral side 110c of the upper platen 110, as shown in FIG. 1B, the pressure distribution system 108 may also ensure that such lateral sides 110c-d lay horizontally flat in the closed position, even if a thick material is between the platen system 102. The pressure distribution system 108 may also provide an opposite restoring force when the upper platen 110 is being pressed on the lower platen 112. Such opposite restoring force may balance the pressing force applied by the motor 218 to a desired magnitude. Additionally, such opposite restoring force may in some examples trigger the motor 218 that actuates the upper platen 110 to provide increasing force when sensing such resistive force.

As shown in FIG. 2A, the pressure distribution system 108 may have a distribution plate 206 attached to the actuator arm 120. The distribution plate 206 may evenly distribute the compressing force from the actuator arm 120 to a plurality of compression springs 202a-b coupled under the distribution plate 206 and configured to traverse upwards and downwards. Consequently, the distribution plate 206 may distribute the compressing force to the compression springs 202a-b and allow such structures to flatten the upper platen 110 evenly on the lower platen 112 and on the objects between the two platens, as described elsewhere herein. The distribution plate 206 may have two or more rows of holes, where each hole receives an axial shaft 204a-b. The axial shafts 204a-b may be vertically coupled between the external surface of the upper platen 110 and the distribution plate 206. Each axial shaft 204a-b may be surrounded by a compression spring 202a-b coupled between the distribution plate 206 and the upper platen 110.

The pressure distribution system 108 may have a plurality of rear compression springs 202a under the distribution plate 206 that are closest to the rear lateral side 110c of the upper platen 110. Such rear compression springs 202a may be arranged in a row that is parallel to the laterals sides 110c-d of the upper platen 110. The pressure distribution system 108 may also have a plurality of front compression springs 202b under the distribution plate 206 that are closest to the front lateral side 110d of the upper platen 110. Such front compression springs 202b may be arranged in a row that is parallel to the lateral sides 110c-d of the upper platen 110. Each row of the front and rear compressions springs 202a-b may each have between two to six compression springs. In some examples, each row of the front and rear compressions springs 202a-b may each have greater than six compression springs. Each row of compression springs 202a-b may align with the rows of holes on the distribution plate 206. Each compressions spring 202a-b may have an axial shaft 204a-b in the center of the spring, which such axial shaft 204a-b may prevent the compression springs 202a-b from wobbling sideways and allow the springs to move only in the vertical direction. The vertical displacement of the compression springs along the axial shafts 204a-b may also visibly indicate what magnitude of compressing is being applied by the motor 218 to the platen system 102, as described elsewhere herein. By way of example and not limitation, the compression springs 202a-b may be straight coil springs, variable pitch springs, or a combination thereof. Other types of springs or structures providing restoring force and distribution of force are also contemplated herein.

The pressure distribution system 206 may have rear and front axial shafts 204a-b. The rear axial shafts 204a may be arranged in between the longitudinal sides 110a-b of the upper platen 110, where each rear axial shaft 204a may align and be inserted in a rear hole of the distribution plate 206 that are also arranged in rows. Similarly, the front axial shafts 204b may be arranged in a row, where each front axial shaft 204b may align and be inserted in a front hole of the distribution plate 206 that are also arranged in rows. The rear and front axial shafts 204a-b may be vertically slidable relative to the distribution plate 206 and each shaft may be surrounded by a compression spring 202a-b that provides restoring force when compressed and displaced vertically. Each axial shaft 204a-b may have a bolt head having a bigger diameter than the holes in the distribution plate 206 such that the shaft does not accidentally decouple with the distribution plate 206. Each row of rear and front axial shafts 204a-b may have between two to six axial shafts. In some examples, each row of rear and front axial shafts 204a-b may have greater than six axial shafts. The axial shafts 204a-b may allow the compression springs 202a-b to be displaced and guided vertically and not wobble side-to-side when compressing force is applied to the pressure distribution system 108 and the platen system 102 by the actuation system 104. Consequently, the axial shafts 204a-b may also prevent the upper platen 110 from wobbling side-to-side since such shafts 204a-b have one end attached to external surface of the upper platen 110.

Referring now to FIG. 3A, the user interface 124 and the selectable options displayed thereon are shown. The user interface may be a touchpad screen 124 or a combination of a screen and keypads. The touchpad screen 124 may display options for adjusting the applied pressure, the heating temperature, and the pressing time the heat press 100 executes on the platen system 102 and the objects therebetween. The touchpad screen 124 may also allow for the automatic closing and opening of the platen system 102 by the actuation system 104.

The preset configurations 302 displayed on the touchpad screen 124 may provide a plurality of options for the amount of pressure the upper platen 110 applies to the lower platen 112. The preset configurations 302 may allow for a user to select between light, medium, and high pressure. The selectable pressure from the preset configurations 302 may be constant pressures or increasing pressures with time, as described elsewhere herein. If the preset configurations 302 display options for light, medium, or high increasing pressure with time, such rate of increase may be driven and controlled as described elsewhere herein. The pressure magnitude or rate of change for each preset configuration 302 option may be adjusted (e.g., increased or decreased) using the touchpad screen 124 by accessing the back-end programming of the heat press 100. In some examples, the heat press 100 may be configured to switch between providing constant pressure and increasing pressure over time, described elsewhere herein. The touchpad screen 124 may be used to access the back-end programming of the digital controller 106 to make such switch in the type of pressure and update the preset configurations 302 accordingly, based on what type of pressure setting is selected. In other examples, the heat press 100 may be configured to switch between the methods of driving and controlling the rate of increase in pressure over time, described elsewhere. The touchpad screen 124 may be used to access the back-end programming of the digital controller 106 to make such switch in the type of pressure and update the preset configurations 302 accordingly, based on what type of pressure setting is selected.

The heating temperature 306 of the heating element 226 in the upper platen 110 may be adjusted using the touch pad screen 124. The heating temperature 306 may be displayed and switched between both Fahrenheit and Celsius. The heating temperature 306 may be increased and decreased using the toggle digital keys 308a-b displayed on the touch pad screen 124.

The timer 304 displayed on the touchpad screen 124 may display both the selected time amount and the lapsed time. Such times may be displayed in seconds, minutes, or a combination thereof. In some examples, the timer 304 may keep track of the time of how long the platen system 102 has been closed and heating the objects therebetween. In some examples, the timer 304 may keep track of the time of how long the platen system 102 is pressing together and applying the selected pressure. The pressing time and the closing time may equal to each other or may not equal each other. In another example, the timer may keep track of the time of how long the motor 218 of the actuating system 104 has been turned on, which may include the time the upper platen 110 is moved towards the lower platen 112. The heat press 100 may be configured to keep track of a combination, or all, of the aforementioned times, and the touchpad screen 124 may be used to access the back-end programming to switch what the timer 304 is keeping track thereof.

The toggle up and down 308a-b buttons may be used to adjust the heating temperature 306, the duration of time on the timer 304, and the pressure rate and magnitude accessible in the back-end. The setting button may be used to select between the heating temperature 306 and timer 304 option and also access the back-end programming. In other examples, the back-end programming may be accessed by pressing and holding a toggle button 308a-b and a preset configuration 302 option. The start button 310 may also be used to actuate the actuation system 104 and press the platens together.

Referring now to FIGS. 3B-E, the pressing of the upper platen 110 on the lower platen 112, with a garment 301 and transfer material 303 therebetween, is shown at different pressure levels. FIG. 3C may correspond to light pressure pressing whereas FIG. 3D may correspond to high pressure pressing, and FIG. 3E may correspond to medium pressure pressing. As shown in FIG. 3C, the compression springs 202a-b of the pressure distribution system 108 may have equilibrium spring displacements 314a, 316a when light pressure, described elsewhere herein, is applied to the platen system 102. This may be because the pressure applied to the platen system 102 may be less than the force necessary to compress the springs 202a-b. The light applied pressure shown in FIG. 3C may be a constant pressure or an increasing pressure over time, as described elsewhere herein. The increasing pressure over time may be driven and controlled as described elsewhere herein.

As shown in FIG. 3D, the compression springs 202a-b of the pressure distribution system 108 may have a maximum compression displacement 314c, 316c when high pressure, described elsewhere herein, is applied to the platen system 102. This may be because the pressure applied to the platen system 102 may be greater than or equal to the force needed to fully compress the springs 202a-b. The high applied pressure shown in FIG. 3D may be a constant pressure or an increasing pressure over time, as described elsewhere herein. The increasing pressure over time may be driven and controlled as described elsewhere herein.

As shown in FIG. 3E, the compression springs 202a-b of the pressure distribution system 108 may be partially displaced 314b, 316b from the equilibrium position when a medium pressure, described elsewhere herein, is applied to the platen system 102. This may be because the pressure applied to the platen system 102 may be less than the force needed to fully compress the springs 202a-b, but greater than the force needed to compress and displace the springs 202a-b partially. The medium applied pressure shown in FIG. 3D may be a constant pressure or an increasing pressure over time, as described elsewhere herein. The increasing pressure over time may be driven and controlled as described elsewhere herein. The displacement 316b of the front springs 202b may be equal or greater than the displacement 314b of the rear springs 202a when such springs are partially displaced. In other examples, the reverse may be true where the displacement 316b of the front springs 202b may be equal or less than the displacement 314b of the rear springs 202a when such springs are partially displaced.

The clam shell heat press 100 may allow for an automatic pressure optimization by selecting from different preset configurations, described elsewhere herein. By way of example and not limitation, dye sublimation may benefit from the platen system 102 applying a light pressure, where DTF printing and plastisol transfer may require high pressure applied by the platen system 102 of the clam shell heat press 100. Some other printing methods, such as vinyl transfer printing, done with the clam shell heat press 100 may require a medium applied pressure. The clam shell heat press 100 may allow for the automatic calibration of the applied pressure through the selection of a preset configuration 302 (see FIG. 3A). Consequently, the platen system 102 may be actuated to automatically press down the upper platen 110 on the lower platen 112 at the selected preset pressure. Other printing methods, such as heat transfer, are also contemplated herein to be used with the clam shell heat press 100.

Referring now to FIG. 1B, the platen system 102 will further be described. The lower platen 112 may have two longitudinal sides 112a-b and two lateral sides 112c-d and a metal inner surface 116 therebetween. The two longitudinal sides 112a-b of the lower platen 112 may extend along the length of the body frame 126 of the clam shell heat press 100. The two lateral sides 112c-d may extend along the width of the body frame 126 of the heat press 100. The lower platen 112 and its inner surface 116 may be horizontal at all times (i.e., in the open and closed position of the platen system 102). The lower platen 112 may be slidably coupled to the body frame 126, as described elsewhere herein. The metal inner surface 116 of the lower platen 112 may have a plurality of ventilation holes. The metal inner surface 116 may also be covered by a silicone pad 216 (see FIG. 2A) to prevent metal to metal contact of the inner surface 116 of the lower platen 112 with the inner surface 114 of the upper platen 110. The garment or substrate to be heat pressed may go on top of the silicone pad 216 that is on top of the inner surface of the lower platen 112.

The upper platen 110 may have two longitudinal sides 110a-b and two lateral sides 110c-d and an inner metal surface 114 therebetween and facing the inner surface 116 of the lower platen 112. The two longitudinal sides 110a-b of the upper platen 110 may extend along the length of the body frame 126 of the clam shell heat press 100. The two lateral sides 110c-d may extend along the width of the body frame 126 of the heat press 100.

As shown in FIG. 1B, the upper platen 110 may be spaced apart vertically from the lower platen 112 in the open position of the platen system 102. In the open position, the upper platen 110 may also be inclined upwards from the rear lateral side 110c to the front lateral side 110d. The incline angle 118 may range between 10 to 90-degrees and may be measured between the longitudinal side 110a-b of the upper platen 110 and the longitudinal side 112a-b of the lower platen 112 that is horizontal. Preferably, in the open position, the incline angle is 28.1 degrees. In the closed position, as shown in FIG. 1A, the upper platen 110 may lay horizontally flat on the lower platen 112. The incline angle 118 at the closed position would be zero degrees.

The upper platen 110 may automatically traverse into the closed position (see FIG. 1A) and also automatically traverse to the open position (see FIG. 1B) after the duration of time selected by the user has lapsed. In the closed position, the upper platen 110 may be press on the lower platen with a constant pressure. The pressure may be controlled by the motor or by locking the actuation mechanism. In another example, the upper platen 110 may be locked into place with the lower platen 112 via a pneumatically powered locking mechanism between the platens, until the duration of time has lapsed.

The upper platen 110 may be attached to the actuator arm 120 and traverse between open and closed positions. As shown in FIG. 2A, the pressure distribution system 108 may be attached between the upper platen 110 and the actuator arm 120. The actuator arm 120 may be L-shaped. The long leg 120a of the actuator arm may face the upper platen 110 and extend parallel to the longitudinal sides 110a-b of the upper platen 110. The upper platen 110 may be connected to the long leg 120a of actuator arm 120, and the pressure distribution system 108 may be attached between the upper surface of the upper platen 110 and the lower surface of the long leg 120a. The short leg 120b of the actuator arm 120 may be perpendicular to the long leg 120a and extend downward towards the frame body 126. The short leg 120b may be coupled to a leading shaft 222a of the motor 218 (see FIG. 2C) and translate the force/torque generated by the motor 218 into translational motion that lifts the upper platen 110 downwards and upwards, as described elsewhere herein.

As shown in FIG. 1B, the digital controller 106 may have a user interface and a housing. The user interface may be a touch pad screen 124 or a keypad and a screen. The controller housing 122 may have at least some of the electric components making up the digital controller 106 therein. The digital controller 106, specifically the controller housing 122, may be attached to the upper surface of the long leg 120a of the actuator arm 120. As described elsewhere herein, the digital controller 106 may be used to control the operation of the clam shell heat press 100.

In some examples, there may be a slight vertical spacing 214 between the upper and lower platens 110, 112 in the closed position of the platen system 102, as shown in FIG. 2A. In some examples, the vertical spacing 214 may be eliminated or adjusted by vertically adjusting the lower platen 112. In some examples, additional silicone padding 216 may be placed in between the two platens to fill in the vertical spacing 214. The narrowing and widening of the vertical spacing 214 may also be used to adjust the amount of pressure the upper platen 110 exerts on the lower platen 112. Narrowing the vertical spacing 214 may increase the applied pressure by the actuation system 104 pressing the upper platen 110 on the lower platen 112. Widening the vertical spacing 214 may decrease the applied pressure by the actuation system 104 pressing the upper platen 110 on the lower platen 112. This may be because, in some examples, the actuation system 104 may be calibrated to provide compressing force based on the vertical positioning of the lower platen 112 relative to the upper platen 110 in the closed position.

The lower platen 112 may be horizontally slidable and coupled to a sliding drawer 208. One or more couplers 210 may couple the lower platen 112 with the sliding drawer 208. When the upper platen 110 is in the open position, the lower platen 112 may slide outward from the frame body 126. The sliding drawer 208 may allow for a safer operation of the heat press 100 since a user may slide the lower platen 112 away from the heated upper platen 110 in the open position. The sliding drawer 208 may also increase efficiency in production using the heat press 100 by streamlining the operation of the device.

Referring now to FIG. 2E, the heating element 226 of the clam shell heat press 100 is shown. The heating element 226 may be within the upper platen 110 and be distributed behind the inner surface area 114 (see FIG. 1B) of the upper platen 110. The heating element 226 may convert electricity to heat on the inner surface 114 of the upper platen 110. When the upper platen 110 is pressed against the lower platen 112, having transfer material 303 and a garment 301 therebetween, the heat may cause the graphic on the transfer material 303 to be transferred on the garment 301. The heating temperature of the heating element 226 for different materials and different printing methods may be adjustable using the digital controller 106. The heating element 226 may continuously be turned on, when the heat press 100 is turned on, or the heating element 226 may turn on and produce heat during the duration that the upper platen 110 closes on top of the lower platen 112.

The heating element 226 may have one solid metal piece that covers the length and width of the upper platen 110. The solid metal piece may be made from cast aluminum. The solid metal piece of the heating element 226 may have a plurality of ribs 228 formed in the metal piece body. The plurality of ribs 228 may cover and loop back and forth along the metal piece body of the heating element 226. The plurality of ribs 228 may be hollow and contain heating coils that convert electricity into heat. Consequently, an even heat distribution may form on the inner surface 114 of the upper platen 110 that is designed to press against the inner surface 116 of the lower platen 112.

The clam shell heat press 100 may be configured to apply pressure as a function of the time that the motor 218 is active and traversing the upper platen 110 toward the lower platen 112. As the upper platen 110 moves from the open position, it rotates toward the lower platen 112. During operation, when the upper platen 110 contacts the transfer material 303 and the base material (e.g., garment 301) positioned between the upper platen 110 and the lower platen 112, the upper platen 110 eventually stops moving. In some instances, the upper platen 110 may rotate approximately 45.3 degrees from the open position before it stops moving. However, the pressure applied by the upper platen 110 may continue to increase pressure to the transfer material 303, base material 301, and the lower platen 112. The motor is still on and increasing pressure. When the user-defined time period that the motor 218 is turned on is finished, the motor 218 stops increasing the pressure applied by the upper platen 110 and is held at that pressure for a set period of time as may be prescribed by the user.

For subsequent transfers, the upper platen 110 may be returned to the same starting angular position to ensure repeatable consistent applied pressure. Preferably, the starting angular position is between 25-90 degrees to permit the user to insert and remove the base material and transfer material between the upper and lower platens and not touch the hot upper platen. More preferably, the starting angular position is 28.1 degrees. The time period that motor 218 traverses the upper platen 110 to the same starting position may be less than the time period that the motor 218 traverses the upper platen 110 to the closed position and also continues to increase pressure applied to the transfer material 303, base material 301, and the lower platen 112. When the upper platen 110 is returned to the same starting position, this ensures that for the next transfer, the upper platen 110 moves the same rotational angle (e.g., 45.3 degrees) to apply the same pressure to the transfer material 303, base material 301, and lower platen 112. The starting position of the upper platen 110 may be set to a maximum open position, or to an angle other than the maximum, depending on the specific preset configuration selected via the digital controller 106. If the starting position is set to be less than the maximum open position, the starting position of the upper platen 110 may be determined by an angular sensor 305, which provides a feedback loop to a processor 307 that turns the motor 218 on or off.

The consistent positioning of the upper platen 110 at the start of each operation allows the motor 218 to traverse the same rotational path, applying uniform pressure with each cycle. This configuration ensures that the upper platen 110 exerts the same amount of force and pressure on the transfer material 303 and base material 301 in each pressing operation. FIG. 1B illustrates the inclined position of the upper platen 110 in the open position, and FIGS. 2C-D show the coupling between the motor 218, leading shaft 222a, and actuator arm 120 that facilitates this controlled movement.

The above description is given by way of example, and not limitation. Given the above disclosure, one skilled in the art could devise variations that are within the scope and spirit of the invention disclosed herein. Further, the various features of the embodiments disclosed herein can be used alone, or in varying combinations with each other and are not intended to be limited to the specific combination described herein. Thus, the scope of the claims is not to be limited by the illustrated embodiments.

What is claimed is:

1. A clam shell heat press for applying a preset pressure and heat between a graphic design and a garment to transfer the graphic design onto the garment, comprising:
a frame body;
a lower platen attached to the frame body, the lower platen having an upper surface that is flat and horizontal;
a pivot pin attached to the frame body, the pivot pin defining a rotational axis;
an upper platen rotatably traversable about the pivot pin between an open position and a closed position, in the open position, the upper platen being spaced above the lower platen at an angle relative to the lower platen, and in the closed position, the upper platen having a flat lower surface configured to press the graphic design and the garment against the lower platen;
an actuating arm coupled to the upper platen and configured to traverse the upper platen between the open position and the closed position, the actuating arm being pivotally attached to the pivot pin wherein the upper platen traverses between the open and closed positions by rotating the upper platen and the actuating arm about the pivot pin;
a motor disposed underneath the lower platen, a first end portion of the motor being coupled to the frame body, a second end portion being coupled to the actuating arm, the motor configured to provide a driving force to rotate the upper platen between the open position and the closed position about the rotational axis, the motor configured to continue providing the driving force after the upper platen has contacted the lower platen to increase pressure to the preset pressure between the upper platen and the lower platen based on a length of time the motor remains in an active state, the motor configured to remain in a passive state to maintain the preset pressure for a time duration; and
a digital controller having a user interface configured to adjust the pressure between the upper platen and the lower platen via the motor.

2. The clam shell heat press of claim 1, wherein the motor returns the upper platen back to a first starting position as the upper platen is moved to the open position, the first start position being a consistent angle for each cycle.

3. The clam shell heat press of claim 2, wherein a second section of the actuating arm is shorter than a first section.

4. The clam shell heat press of claim 3, wherein a length of time that the remains in the active state is less than a length of time the motor is on to traverse the upper platen from the closed position to the first starting position.

5. The clam shell heat press of claim 1, wherein the pivot pin is disposed behind the lower platen.

6. The clam shell heat press of claim 1, wherein the first end portion of the motor is rotatably coupled to the frame body underneath the lower platen.

7. The clam shell heat press of claim 1, wherein the second end portion of the motor is configured to extend away from the motor to move the upper platen to the closed position.

8. The clam shell heat press of claim 1, wherein driving force provided by the motor increases with respect to time.

9. The clam shell heat press of claim 1, wherein driving force provided by the motor is constant with respect to time.

10. A method for using a clam shell heat press to press a graphic design on a garment, comprising:
placing the garment between an upper platen and a lower platen of the clam shell heat press;
placing a transfer material having the graphic design on top of the garment and between the upper platen and the lower platen;
selecting on a user interface a heating temperature;
selecting on the user interface a time duration that the upper platen will press against the lower platen;
selecting on the user interface a preset configuration that determines a length of time that a motor attached to the upper platen will be in an active state and increases a pressure applied between the upper and lower platens in the active state so that pressure between the upper and lower platen maintains a preset pressure during a passive state of the motor;
rotating the upper platen about a rotational axis of an actuating arm, the actuating arm connecting the motor to the upper platen, the motor disposed underneath the lower platen, until the upper platen applies a preset pressure to the lower platen based on the length of time that the motor is in the active state for applying the preset pressure between the graphic design and the garment; and
maintaining a passive state of the motor for the time duration set in the step of selecting on the user interface the time duration.

11. The method of claim 10, wherein the motor is driven by a driving force that increases with respect to time.

12. The method of claim 11, wherein a rate of change of the driving force may be increased or decreased by selecting different preset configurations for pressure wherein each different preset configuration maintains the motor in the active state for each different periods of time of different preset configuration.

13. The method of claim 10, wherein the motor is driven by a driving force that is constant with respect to time in the passive state.

14. The method of claim 13, wherein a magnitude of the driving force in the passive state may be increased or decreased by selecting a different preset configuration for pressure.

15. The method of claim 10, wherein the motor is driven by a driving force that is constant as the upper platen rotates down on the lower platen and the driving force increases during the active state of the motor.

16. The method of claim 10, wherein after the maintaining step, traversing the upper platen back to a first starting position, the first starting position being consistent between each cycle.

17. The method of claim 16, wherein the actuator arm rotates about a pivot pin coupled to a frame of the clam shell heat press, the pivot pin defining the rotational axis of the actuator arm.

18. The method of claim 16, wherein a length of time of the rotating step is greater than a length of time of the traversing step so that the upper platen is set back to the first starting position.

19. The method of claim 18, wherein the motor is driven by a driving force that is constant as the upper platen rotates on the lower platen and the driving force increases as the motor experiences a resistive force from a compression spring.
